(19) United States
(12) Patent Application Publication
(10) Pub. No.: US 2026/0225273 A1
(43) Pub. Date: Aug. 6, 2026

(54) RAZOR CARTRIDGE

(71) Applicant: DORCO CO., LTD., Yongin-si (KR)

(72) Inventor: Sung Hee SON, Seoul (KR)

(21) Appl. No.: 19/636,187

(22) Filed: Apr. 1, 2026

Related U.S. Application Data
(63) Continuation of application No. PCT/KR2024/016433, filed on Oct. 25, 2024.

(30) Foreign Application Priority Data
Oct. 27, 2023 (KR) 10-2023-0145295
Oct. 23, 2024 (KR) 10-2024-0145739

(51) Int. Cl. B26B 21/22

(52) U.S. Cl. CPC B26B 21/225

(57) ABSTRACT

A razor cartridge may include a frame including a receiving space formed therein. The razor cartridge may also include a blade housing receiving at least one shaving blade in a longitudinal direction and mounted on the frame in a mounting direction to enable at least one of movement and rotation with respect to the frame. The razor cartridge may further include a tension supporting unit supporting the blade housing to provide a restorative force to restore the blade housing to a rest position. The frame may further include a first recess formed at a top of a frame side wall and a second recess formed at the frame side wall and spaced apart from the first recess in the mounting direction. The blade housing may be mounted on the frame by inserting a mounting protrusion into the second recess through the first recess.

### CROSS-REFERENCE TO RELATED APPLICATIONS

This is a continuation application of International Patent Application No. PCT/KR2024/016433 filed on October 25, 2024 which claims priority to Korean Patent Application No. 10-2023-0145295, filed on October 27, 2023, and Korean Patent Application No. 10-2024-0145739, filed on October 23, 2024, the entire contents of each of which are incorporated herein by reference in their entirety.

### BACKGROUND

The present disclosure relates to a razor cartridge.

### Description of Related Technology

A razor assembly includes a razor cartridge and a razor handle. The razor cartridge may include a blade housing, a guard bar, a cap, and at least one shaving blade disposed between the guard bar and the cap.

### SUMMARY

One aspect is to improve close-shaving performance by using a blade housing mounted on a frame to be movable and/or rotatable and a tension supporting unit providing a restorative force.

Another aspect is a razor cartridge in which shaving blades retract when excessive pressure is applied to a user's skin, thereby reducing skin irritation during shaving.

The aspects of the present disclosure are not limited to the aspects disclosed herein, and other aspects not mentioned may be clearly understood by those skilled in the art from the following description.

Another aspect is a razor cartridge comprising: a frame comprising a receiving space formed therein; a blade housing receiving at least one shaving blade in a longitudinal direction and mounted on the frame in a mounting direction perpendicular to the longitudinal direction to enable at least one of movement and rotation with respect to the frame; and a tension supporting unit supporting the blade housing to provide a restorative force to restore the blade housing to a rest position when the blade housing moves or rotates relative to the frame, wherein the frame further comprises: a first recess formed at a top of a frame side wall; and a second recess formed at the frame side wall and spaced apart from the first recess in the mounting direction, and wherein the blade housing is mounted on the frame by inserting a mounting protrusion, formed in a housing side wall of the blade housing, into the second recess through the first recess.

Another aspect is a razor cartridge comprising: a frame comprising a receiving space formed therein and at least one recess formed at a side wall; a blade housing receiving at least one shaving blade in a longitudinal direction and mounted on the frame and having a mounting protrusion inserted into the at least one recess, allowing the blade housing to be movable or rotatable relative to the frame; and a tension supporting unit supporting the blade housing to provide a restorative force to restore the blade housing to a rest position when the blade housing moves or rotates relative to the frame, and wherein the mounting protrusion is formed in a central part of a side wall of the blade housing in a transverse direction perpendicular to the longitudinal direction.

According to one embodiment, a razor cartridge has the effect of improving close-shaving performance by using a blade housing mounted on a frame to be movable and/or rotatable and a tension supporting unit providing a restorative force.

According to one embodiment, a razor cartridge is configured with shaving blades that retract when excessive pressure is applied to a user's skin, thereby reducing skin irritation during shaving.

### BRIEF DESCRIPTION OF THE DRAWINGS

FIG. 1 is a perspective view of a razor cartridge according to an embodiment of the present disclosure.

FIG. 2 is a rear perspective view of a razor cartridge according to an embodiment of the present disclosure.

FIG. 3 is an exploded perspective view and a partially enlarged view of a razor cartridge according to an embodiment of the present disclosure.

FIG. 4 is a cross-sectional view taken along line IV-IV' of FIG. 2, showing a mounting protrusion and an inclined portion of a first recess.

FIG. 5 is a side cross-sectional view taken along line V-V' of FIG. 2.

FIG. 6 is a view showing a blade housing moving upward and downward while mounted on a frame according to an embodiment of the present disclosure.

FIG. 7 is a view showing a blade housing pivoting forward and backward while mounted on a frame according to an embodiment of the present disclosure.

FIG. 8 is a view showing a blade housing pivoting about a transverse direction while mounted on a frame according to an embodiment of the present disclosure.

FIG. 9 shows a perspective view of a razor cartridge according to another embodiment of the present disclosure.

FIG. 10 shows a rear perspective view of a razor cartridge according to another embodiment of the present disclosure.

FIG. 11 shows an exploded perspective view and a partially enlarged view of a razor cartridge according to another embodiment of the present disclosure.

### DETAILED DESCRIPTION

A razor cartridge may be pivotable about the razor handle between a rest position and a pivot position. The pivoting of the razor cartridge relative to the razor handle is essentially about a rotational axis parallel to an extending direction of the shaving blade.

When the razor cartridge is configured to rotate about the rotational axis, this helps the shaving blade to make smooth contact with a user's skin, which is a cutting surface, thereby enabling efficient shaving.

However, if a razor cartridge is configured to pivot only about a handle as in the conventional razor assembly described above, there are limitations in the cartridge's ability to closely adhere to the user's skin, which may have various contours. Accordingly, there is a need for an effective structure that further enhances close-shaving performance.

In addition, if a shaving blade comes into strong contact with the user's skin due to excessive force exerted by the user during shaving, the user's skin may get cut by the shaving blade. Therefore, there is a need for a structure that reduces the stimulus applied to the user's skin during shaving.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, a), b), etc., are used solely to differentiate one component from the other but not to imply or suggest the substances, order, or sequence of the components.

When a component is described as being ‘connected’, ‘coupled’, or ‘joined’ to another component, it should be understood that the component may be directly connected or joined to that other component, but another component may also be ‘connected’, ‘coupled’, or ‘joined’ between each component.

Throughout this specification, when a part ‘includes’ or ‘comprises’ a component, the part is meant to further include other components, not to exclude thereof unless specifically stated to the contrary.

The terms ‘… unit’ and ‘module’ as used in the specification refer to a unit that processes at least one function or operation, which may be implemented by hardware, software, or a combination of hardware and software.

Unless otherwise specified, the description of any one embodiment is intended to be applicable to other embodiments as well.

The description of the present disclosure disclosed below, together with the accompanying drawings, is intended to illustrate exemplary embodiments of the present disclosure and is not intended to represent the only embodiments in which the present disclosure may be practiced.

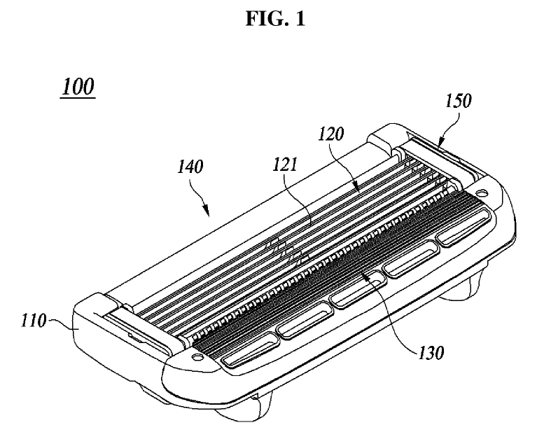

FIG. 1 is a perspective view of a razor cartridge according to an embodiment of the present disclosure.

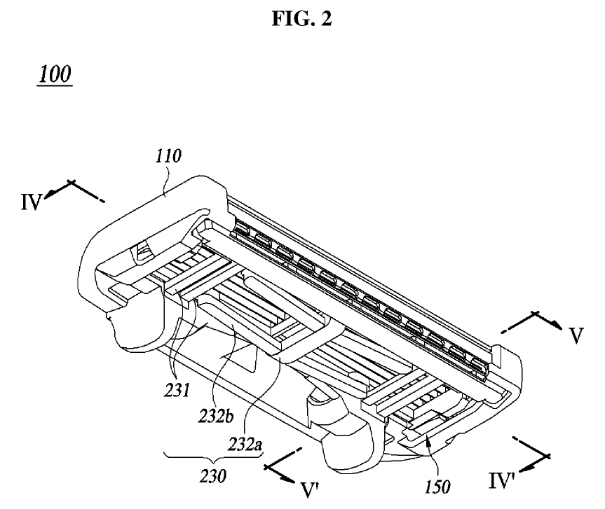

FIG. 2 is a rear perspective view of a razor cartridge according to an embodiment of the present disclosure.

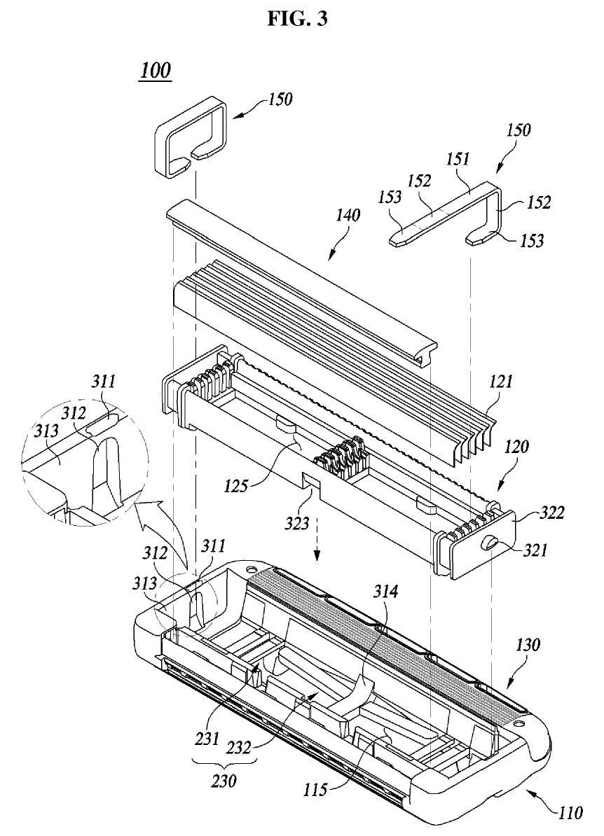

FIG. 3 is an exploded perspective view and a partially enlarged view of a razor cartridge according to an embodiment of the present disclosure.

Referring to FIGS. 1 to 3, a razor cartridge 100 according to one embodiment of the present disclosure includes a frame 110, a blade housing 120, a guard portion 130, a cap portion 140, and/or a tension supporting unit 230. The guard portion 130 and the cap portion 140 may be included in the frame 110.

The frame 110 may include a first recess 311, a second recess 312, a frame side wall 313, and/or a frame alignment member 314.

The blade housing 120 may include a mounting protrusion 321, a housing side wall 322, and/or a blade housing alignment member 323.

The tension supporting unit 230 may include a first supporting unit 231 and a second supporting unit 232.

The second supporting unit 232 may include a base 232a and a leg 232b.

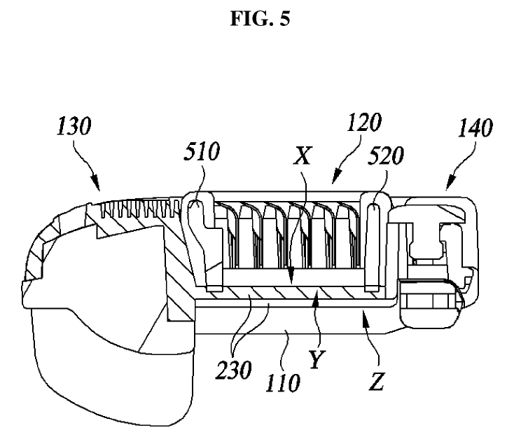

The frame 110 includes a housing receiving space 115 formed therein. The blade housing 120 is mounted in the housing receiving space 115 of the frame110 to be movable and/or rotatable. The blade housing 120 may be mounted on the frame 110 along a mounting direction. Here, the mounting direction is a direction perpendicular to a longitudinal direction, which is an extending direction of the blade housing 120 and the shaving blade 121, such as a vertical direction of FIGS. 5 to 7 (see an arrow in FIG. 3). In other words, the blade housing 120 may include an upper part where the cutting edge of the shaving blade 121 received in the blade housing 120 is exposed, and a lower part opposite to the upper part, and the mounting direction refers to a direction from the upper part toward the lower part. The frame 110 may include one or more recesses 311 and 312 so that the blade housing 120 can be mounted, movable, and/or rotatable. In this case, the rotational axis of the blade housing 120 is defined by the second recess 312 and the mounting protrusion 321. If the second recess 312 and the mounting protrusion 321 are positioned near the upper part of the razor cartridge 100 relative to the mounting direction, the rotational axis of the blade housing 120 is formed close to the user's skin during shaving, thereby facilitating a close shave.

The first recess 311 may be formed at a top of the frame side wall 313 along the longitudinal direction. At least a part of the first recess 311 may be formed to be inclined. For example, at least a portion of the first recess 311 may have a chamfered shape. Similarly, at least a portion of the mounting protrusion 321 may also be formed to be inclined.

As at least a portion of the first recess 311 is formed to be inclined, the mounting protrusion 321 of the blade housing 120 may smoothly mount to the frame 110 through the inclined portion of the first recess 311 when attaching the blade housing 120 to the frame 110. Although FIG. 3 shows the inclined surface of the first recess 311 as flat, the inclined surface of the first recess 311 may be curved.

The second recess 312 may be formed on a frame side wall 313 and spaced apart from the first recess 311 along a mounting direction, that is, a direction in which the blade housing 120 is mounted on the frame 110 (see FIG. 3). One side of the second recess 312 may be spaced apart from the first recess 311 along the mounting direction to accommodate the mounting protrusion 321 of the blade housing 120, and the second recess 312 may be elongated extending from the one side along the mounting direction. Since the second recess 312 is elongated extending from one side along the mounting direction, the blade housing 120 mounted on the frame 110 may move (upward and downward) along a shape of the second recess.

The second recess 312 may be formed at a central part along a transverse direction of the frame side wall 313. Here, the transverse direction refers to a direction perpendicular to the mounting direction and the longitudinal direction. The blade housing 120 of the razor cartridge 100 according to one embodiment of the present disclosure is mounted on the frame 110 by inserting the mounting protrusion 321 into one side of the second recess 312 through the first recess 311. Thus, an initial position (rest position) of the blade housing 120 relative to the frame 110 is determined by the position of one side of the second recess 312 and the position of the mounting protrusion 321.

Meanwhile, regarding the structure in which the blade housing 120 is mounted on the frame 110 according to the present disclosure, it has been described that the mounting protrusion 321 of the blade housing 120 is inserted into the second recess 312 through the first recess 311 of the frame 110, but the mounting structure is not limited to this example. That is, a protrusion for mounting may be formed in the frame side wall 313 and one or more recesses may be formed in the housing side wall 322 of the blade housing 120, resulting in a structure where the blade housing 120 is mounted on the frame 110 in a reversed male-female configuration.

A frame alignment member 314 may be formed in a front and/or rear wall of any one of the frame 110 and the blade housing 120 along the transverse direction, and a blade housing alignment member may be formed in a front and/or rear wall of the other one. FIG. 3 illustrates a case where the frame alignment member 314 is formed as a protrusion at the front and/or rear wall of the frame 110 and the blade housing alignment member 323 is formed as a recess at the front and/or rear wall of the blade housing 120, but aspects of the present disclosure is not necessarily limited to this structure. That is, the frame alignment member 314 and the blade housing alignment member 323 may have a reversed male-female configuration, where the frame 110 has a recess-type alignment member 314 and the blade housing 120 has a protrusion-type alignment member. Hereinafter, it will be described that the frame alignment member 314 is shaped as a protrusion and the blade housing alignment member 323 is shaped as a recess.

Referring to FIG. 3, the frame alignment member 314 may be formed in the front and/or rear wall of the frame 110, and a blade housing alignment member 323 may be formed in the front and/or rear wall of the blade housing 120.

The frame alignment member 314 may be formed inside the housing receiving space 115 to protrude forward from the rear wall of the frame 110 and/or protrude backward from the front wall. The blade housing alignment member 323 may be formed in the front and/or rear of the blade housing 120. As shown in FIG. 3, a blade housing alignment member 323 formed at the front of the blade housing 120 may be formed in a bottom surface of the blade housing 120 along a direction extending rearward from the front wall, allowing the frame alignment member 314 to be inserted when the blade housing 120 is mounted on the frame 110. A blade housing alignment member 323 formed at the rear of the blade housing 120 may be formed in the bottom surface along a direction extending forward from the rear wall.

When the blade housing 120 is mounted on the frame 110, the frame alignment member 314 may be inserted into the blade housing alignment member 323 to prevent the blade housing 120 from wobbling in the longitudinal direction or other directions due to manufacturing tolerances of the components. The frame alignment member 314 and the blade housing alignment member 323 may prevent the blade housing 120 from wobbling without preventing the blade housing 120 from moving and/or rotating while mounted to the frame 110. Additionally, the frame alignment member 314 and the blade housing alignment member 323 may prevent the blade housing 120 from excessively moving downward relative to the frame 110.

The blade housing 120 receives at least one shaving blade 121 in the longitudinal direction. The blade housing 120 is mounted to the frame 110 along the mounting direction to be movable and/or rotatable. The blade housing 120 may be mounted inside the frame 110, that is, in the housing receiving space 115. The blade housing 120 may be able to move upward and downward along a direction parallel to the mounting direction while mounted on the frame 110. The blade housing 120 may be rotatable about a straight line parallel to the longitudinal direction while mounted on the frame 110. The blade housing 120 may be configured to rotate (tilt) about a straight line parallel to the transverse direction while mounted on the frame 110. That is, the blade housing 120 may be configured to move, rotate front-to-back, and/or rotate side-to-side while mounted on the frame 110. This movement of the blade housing 120 enables close contact between a user's skin and the razor cartridge 100, resulting in a close shave.

Referring to FIG. 3, a razor cartridge 100 according to one embodiment of the present disclosure may be assembled in the following order.

First, at least one razor blade 121 may be disposed within a blade receiving space 125 of a blade housing 120. Thereafter, in order to secure the at least one razor blade 121 disposed within the blade housing 120, a clip 150 may be positioned at a position adjacent to a housing side wall 322, and at least a portion of the clip 150 may be bent to secure the clip 150 to the blade housing 120. In this case, one surface of the clip 150 may come into contact with a cutting edge. Thereafter, the blade housing 120, in which the assembly of the at least one razor blade 121 and the clip 150 is completed, may be mounted on a frame 110 according to the mounting direction. Meanwhile, a cap portion 140 may be mounted on a rear side of the frame 110 regardless of the above-described assembly order.

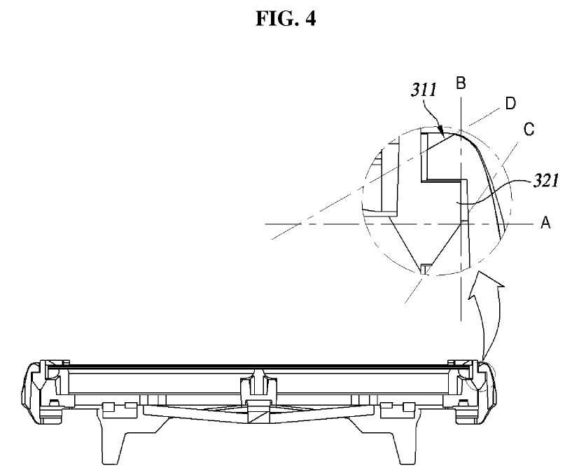

FIG. 4 is a cross-sectional view taken along line IV-IV' of FIG. 2, showing a mounting protrusion and an inclined portion of a first recess.

Referring to FIG. 4, as viewed in a cross section cut along the longitudinal direction, the first recess 311 may be formed with at least a portion inclined from a straight line A parallel to the longitudinal direction and a straight line B parallel to the mounting direction. That is, the first recess 311 may be formed in a manner where a straight line D extending from the at least part of the first recess 311 is at predetermined angle relative to the straight lines A and B. In this regard, the mounting protrusion 321 may also be formed with at least a portion inclined from the straight line A parallel to the longitudinal direction the straight line B, which is parallel to the mounting direction. That is, the mounting protrusion 321 may be formed in a manner where a straight line C extending from the at least a portion of mounting protrusion 321 is at a predetermined angle relative to the straight lines A and B.

As at least a portion of the first recess 311 is formed to be inclined, the mounting protrusion 321 of the blade housing 120 may smoothly mount to the frame 110 through the inclined portion of the first recess 311 when attaching the blade housing 120 to the frame 110. Although the inclined surface of the first recess 311 is shown as a flat surface in FIGS. 3 and 4, the inclined surface of the first recess 311 may be in a curved shape.

The inclined portion of the first recess 311 may be formed to correspond to the inclined portion of the mounting protrusion 321 (for example, so that the straight line D extending from the inclined portion of the first recess 311 and the straight line C extending from the inclined portion of the mounting protrusion 321 in FIG. 4 are parallel to each other), but aspects of the present disclosure are not limited to this example. That is, various configurations may be designed to facilitate the easy mounting of the blade housing 120 to the frame 110, as exemplified in FIG. 4 where the straight line D extending from the inclined portion of the first recess 311 and the straight line C extending from the inclined portion of the mounting protrusion 321 intersect each other.

As viewed in a cross section cut along the longitudinal direction, the mounting protrusion 321 may be formed with at least a portion inclined from the straight line A parallel to the longitudinal direction and the straight line B parallel to the mounting direction. That is, the mounting protrusion 321 may be formed in a manner where a straight line C extending from at least a portion of the mounting protrusion is at a predetermined angle relative to the straight lines A and B. Accordingly, as an example, the mounting protrusion 321 may have a partially chamfered shape.

As at least a portion of the mounting protrusion 321 is formed to be inclined, the mounting protrusion 321 may smoothly mount to the frame 110 through the first recess 311 when attaching the blade housing 120 to the frame 110.

As described above, the inclined portion of the mounting protrusion 321 may be formed to correspond to the inclined portion of the first recess 311, but aspects of the present disclosure are not limited this example. That is, various configuration may be designed, as exemplified in FIG. 4 where the straight line C extending from the inclined portion of the mounting protrusion 321 intersects the straight line D extending from the inclined portion of the first recess 311.

The razor cartridge 100 according to one embodiment of the present disclosure may be formed with at least a portion (e.g., a lower portion) of the mounting protrusion 321 formed inclined and at least a portion (e.g., an upper portion) of the first recess 311 formed inclined, thereby facilitating easy mounting of the blade housing 120 onto the frame 110. However, it is not necessary for both the mounting protrusion 321 and the first recess 311 to have an inclined portion, and only one of the mounting protrusion 321 or the first recess 311 may be formed with an inclined portion to allow the blade housing 120 to be easily mounted on the frame 110.

FIG. 5 is a side cross-sectional view taken along line V-V' of FIG. 2, showing the blade housing 120 mounted on the frame 110 and positioned at a rest position.

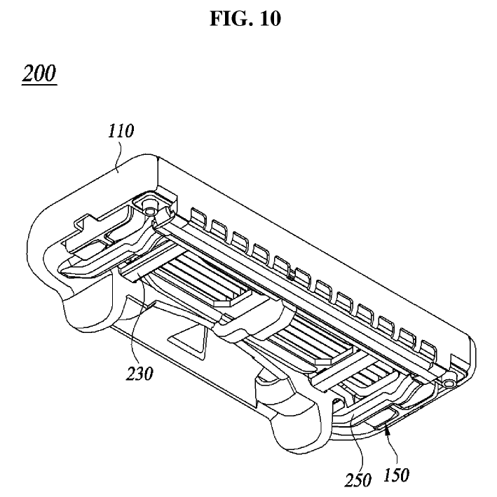

Referring to FIG. 5, the blade housing 120 is mounted on the frame 110 such that at least a portion (e.g., a lower portion) of a contact surface Y of the tension supporting unit 230 contacting the blade housing 120 at the rest position is positioned above a contact surface Z of the frame 110. Here, the contact surface Z of the frame 110 refers to a portion part that comes into contact with a bottom surface X of the blade housing 120 as the blade housing 120 moves downward. For example, a contact surface X of the frame 110 according to one embodiment of the present disclosure may be formed on a wall extending in the longitudinal direction from a lower portion of the frame side wall 313, and the contact surface X of the frame 110 according to another embodiment of the present disclosure may be formed on a rib 250 in FIG. 10.

Accordingly, by mounting the blade housing 120 on the frame 110 such that the contact surface Y of the tension supporting unit 230 is positioned above the contact surface Z of the frame 110 when the blade housing 120 is in the shaving position, the blade housing 120 may move downward from the rest position and may be restored upward again by a restorative force provided by the tension supporting unit 230, thereby enabling the blade housing 120 to move vertically. In addition, as the blade housing 120 moves downward, the bottom surface X thereof comes into contact with the contact surface Z of the frame 110, restricting the downward movement of the blade housing 120 and preventing excessive displacement of the blade housing 120, which could lead to detachment from the frame 110.

Meanwhile, in a state where the blade housing 120 is at the rest position, a shaving plane may be defined by a front member 510 and rear member 520 of the blade housing 120. The blade housing 120 may be mounted on the frame 110 such that the shaving plane defined by the front member 510 and rear member 520 at the rest position is either identical to or positioned above a plane connecting an upper surface of the guard portion 130 and an upper surface of the cap portion 140 of the frame 110. To further enhance the adherence between the razor cartridge 100 and a user's skin surface, the blade housing 120 may be mounted on the frame 110 with a greater distance between the shaving plane defined by the front member 510 and rear member 520 of the blade housing 120 and the plane connecting the upper surface of the guard portion 130 and the upper surface of the cap portion 140.

As described, to transmit the restorative force from the tension supporting unit 230 to the blade housing 120, the blade housing 120 may be mounted on the frame 110 in a manner in which at least a portion (e.g., the bottom surface) contacts the tension supporting unit 230. Consequently, the blade housing 120 may be restored to the rest position by the restorative force transmitted from the tension supporting unit 230. In this case, in the initial state of the blade housing 120 being mounted to the frame 110, where the blade housing 120 is at the rest position, the blade housing 120 may compress the tension supporting unit 230 (for example, compressing the tension supporting unit 230 within 0.1mm to 0.3mm along the mounting direction, preferably 0.2mm). Consequently, during the assembly of the blade housing 120 and the frame 110, phenomena such as rattling caused by the blade housing 120 being spaced apart from the frame 110 due to injection or assembly tolerances or the like may be prevented, ensuring stable attachment of the blade housing 120 to the frame 110.

The mounting protrusion 321 may be formed in the housing side wall 322 along the longitudinal direction of the blade housing 120. The mounting protrusion 321 may be formed to protrude toward the longitudinal direction on both side walls 322 of the blade housing 120. As described above, the blade housing 120 may be mounted on the frame 110 by inserting the mounting protrusion 321 into the second recess 312 through the first recess 311. The initial position of the blade housing 120 mounted on the frame 110 is determined by the positions of the mounting protrusion 321 and the second recess 312.

The mounting protrusion 321 may be formed in a central part along the transverse direction of the housing side wall 322. Here, the central part may refer to an area with a highest density of shaving blades 121 among the areas along the transverse direction of the blade housing 120. For example, if three shaving blades 121 are arranged from the front wall of the blade housing 120 to the 1/3 point along the transverse direction, five shaving blades 121 are arranged from the 1/3 point to the 2/3 point, and three shaving blades 121 are again arranged from the 2/3 point to the rear wall of the blade housing 120, the central part of the side wall 322 may refer to an area from the 1/3 point to the 2/3 point. Therefore, if the shaving blades 121 are predominantly arranged at the front or rear of the blade housing 120, the mounting protrusion 321 may also be disposed at the front or rear along the transverse direction of the housing side wall 322. In this case, the shaving force may be concentrated only in the area close to the mounting protrusion 321, causing the blade housing 120 to rotate rather than move up and down; however, aspects of the present disclosure are not limited to this example.

In addition, a plurality of mounting protrusions 321 may also be formed along the transverse direction of the housing side wall 322, and the frame 110 may have a plurality of first recesses 311 and a plurality of second recesses 312 to receive the plurality of mounting protrusions 321. In this case, the vertical movement of the blade housing 120 relative to the frame 110 may be provided stably than rotational movement of the blade housing 120.

Meanwhile, when a plurality of shaving blades 121 is uniformly arranged at equal intervals along the transverse direction of the blade housing 120, the central part of the housing side wall 322 may correspond to the midpoint along the transverse length of the housing side wall 322.

As the mounting protrusions 321 are positioned at the central part along the transverse direction of the housing side wall 322, the rotational axis of the blade housing 120 rotating relative to the frame 110 is located at the central part along the transverse direction, unlike a typical rotating razor cartridge, where the rotational axis is placed adjacent to the foremost blade. Consequently, this ensures that the shaving force transmitted to the razor cartridge 100 during shaving is evenly distributed across the entire area of the blade housing 120, encompassing the plurality of shaving blades 121. Meanwhile, it should be noted that the razor cartridge 100 according to one embodiment of the present disclosure does not solely enable movement and/or rotation of the blade housing 120 relative to the frame 110, but may also enable movement and/or rotation of the razor cartridge 100 relative to a shaving handle.

According to one embodiment of the present disclosure, the razor cartridge 100 is configured such that the first recess 311 formed at the top of the frame side wall 313 and/or the mounting protrusion 321 formed in the housing side wall 322 is formed with at least a portion formed inclined, the second recess 312 is formed elongated, spaced apart from the first recess 311 along the mounting direction. The mounting protrusion 321 is inserted into the second recess 312 through the first recess 311 to mount the blade housing 120 to the frame 110, thereby facilitating easily mounting of the blade housing 120 to the frame 110. As the first recess 311 and the second recess 312 are spaced apart from each other, the mounted blade housing 120 may not be easily separated from the frame 110.

The tension supporting unit 230 is disposed to support the blade housing 120. Specifically, when the blade housing 120 moves and/or rotates relative to the frame 110, the tension supporting unit 230 supports the blade housing 120 to provide a restorative force so as to return the blade housing 120 to the rest position.

The tension supporting unit 230 is configured to provide a restorative force to the blade housing 120. For example, the tension supporting unit 230 may include elastic materials (e.g., rubber, plastic, etc.).

To transmit a restorative force to the blade housing 120 moved and/or rotated from the rest position, the tension supporting unit 230 may be positioned to contact at least a portion of one side (e.g., the bottom surface) of the blade housing 120 when the blade housing 120 is mounted to the frame 110. The tension supporting unit 230 may be integrally formed with the frame 110. The first supporting unit 231 may be manufactured by dual-injection molding with the frame 110, and the second supporting unit 232 may be formed as a separate member and mounted in the frame 110, but it may also be injection molded together with the frame 110 to form an integral structure.

The first supporting unit 231 may be arranged to transversely cross a lower part of the frame 110. The first supporting unit 231 may be formed in a bridge shape that transversely cross an open lower side of the frame 110. There may be one or more first supporting units 231, preferably a plurality of first supporting units 231. The first supporting unit 231 may be disposed on one side and/or the other side of the frame 110 in the longitudinal direction. The first supporting unit 231 may be formed of a rubber material. When at least a portion (e.g., the bottom surface) of the blade housing 120 mounted to the frame 110 comes into contact with the first supporting unit 231, the first supporting unit 231 may transmit a restorative force to move and/or rotate the blade housing 120 back to the rest position.

On the side cross-sectional view of FIG. 5, the first supporting unit 231 may be disposed such that the contact surface Y of the tension supporting unit 230 is positioned above the contact surface Z of the frame 110. In addition, in the initial state where the blade housing 120 is mounted to the frame 110 (i.e., at the rest position of the blade housing 120), the blade housing 120 may compress the tension supporting unit 230 (for example, compressing the tension supporting unit 230 within 0.2mm along the mounting direction). Consequently, during the assembly of the blade housing 120 and the frame 110, phenomena such as rattling caused by the blade housing 120 being spaced apart from the frame 110 due to injection or assembly tolerances or the like may be prevented, ensuring stable attachment of the blade housing 120 to the frame 110.

The second supporting unit 232 may include a base 232a fixed to the lower part of the frame 110, and a plurality of legs 232b extending from the base 232a to support the blade housing 120. The base 232a may be formed to extend along the transverse direction. Each of the plurality of legs 232b may extend from the base 232a to have at least a portion adjacent to the bottom surface of the blade housing 120. Each leg 232b may extend from the base 232a in a direction different from the longitudinal direction so that at least a portion is directed toward the blade housing 120. Each leg 232b may extend to form a predetermined angle relative to a line parallel to the longitudinal direction. As each leg 232b extends from the base 232a in a direction different from the longitudinal direction, causing at least a portion of a corresponding leg 232b to contact the bottom surface of the blade housing 120, the second supporting unit 232 may provide a restorative force to the blade housing 120. The second supporting unit 232 may be formed of a plastic material.

In addition, compared to a case where the tension supporting unit 230 includes only the second supporting unit 232 and a case where the tension supporting unit 230 includes both the first supporting unit 231 and the second supporting unit 232, smoother movement and pivoting motion of the blade housing 120 with respect to the frame 110 may be provided. In addition, when the tension supporting unit 230 does not include the second supporting unit 232, which has a relatively larger area, the area of an open region of the frame 110 formed along a mounting direction may be further widened.

The razor cartridge 100 according to one embodiment of the present disclosure may include the guard portion 130 and the cap portion 140. The guard portion 130 may be disposed at the front of the frame 110, and the cap portion 140 may be disposed at the rear of the frame 110.

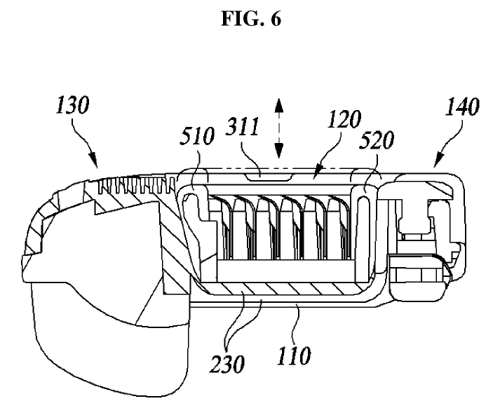

FIG. 6 is a view showing the blade housing 120 moving upward and downward while mounted on the frame 110 according to an embodiment of the present disclosure.

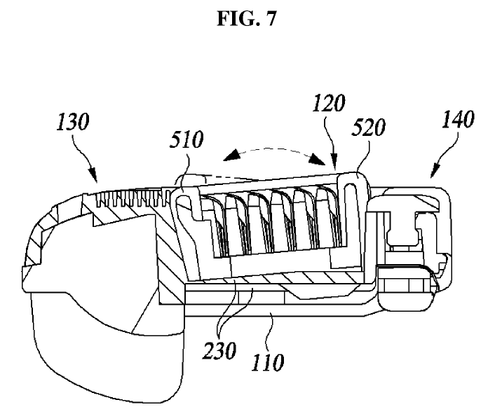

FIG. 7 is a view showing the blade housing 120 rotating back and forth while mounted on the frame 110 according to an embodiment of the present disclosure.

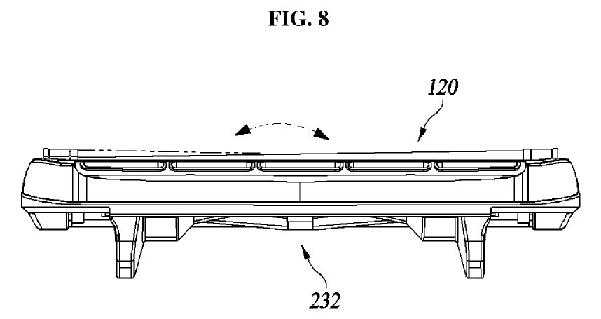

FIG. 8 is a view showing the blade housing 120 rotating about the transverse direction while mounted on the frame 110 according to an embodiment of the present disclosure.

Referring to FIGS. 6 to 8, as described above, the blade housing 120 of the razor cartridge 100 according to one embodiment of the present disclosure is mounted on the frame 110 to be movable and/or rotatable relative to the frame 110.

Specifically, as shown in FIG. 6, the blade housing 120 may move downward in a mounting direction from the rest position and may return upward to the rest position due to a restorative force transmitted from the tension supporting unit 230. For example, the blade housing 120 may move between 0.5mm and 2.0mm, preferably about 1.0mm, in the mounting direction from the rest position.

In addition, as shown in FIG. 7, the blade housing 120 may rotate forward and backward about a straight line parallel to a longitudinal direction from the rest position, and may return to the rest position due to a restorative force transmitted from the tension supporting unit 230. For example, the blade housing 120 may rotated between 2° and 8°, preferably about 5°, frontward and backward.

As shown in FIG. 8, as described above, the blade housing 120 according to one embodiment of the present disclosure may also rotate (tilt) about a straight line parallel to the transverse direction while mounted on the frame 110.

Using the blade housing 120 mounted on the frame 110 to be movable and/or rotatable and the tension supporting unit 230, the razor cartridge 100 according to one embodiment of the present disclosure may enhance close-shaving performance and reduce a user’s skin irritation during shaving. In addition, the structure including the first recess 311, the second recess 312, and the mounting protrusion 321 may allow the blade housing 120 to be easily mounted onto the frame 110, but does not allow the mounted blade housing 120 to be easily separated from the frame 110. Furthermore, as the mounting protrusion 321 is disposed at a central part along the transverse direction of the housing side wall 322, a shaving force may be evenly distributed.

Meanwhile, as described above, the shaving plane of the razor cartridge 100 may be defined by the front member 510 and the rear member 520 of the blade housing 120. When the blade housing 120 moves vertically relative to the frame 110, as shown in FIG. 6, the shaving plane may be positioned below or on the same level as a plane connecting the guard portion 130 and cap portion 140. Thus, even if the razor cartridge 100 passes over the user's excessively curved skin, the shaving plane defined by the blade housing 120 may be supported by a wide area formed by the guard portion 130 and the cap portion 140, ensuring safe hair cutting.

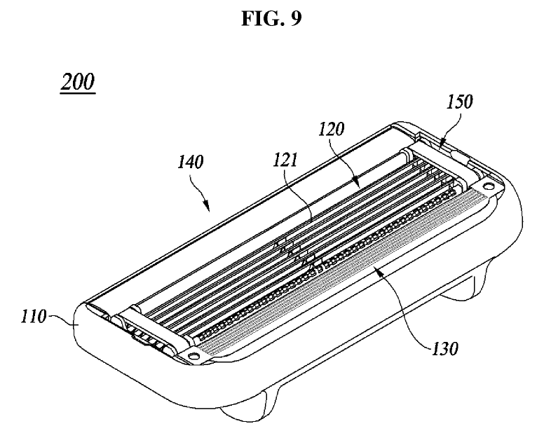

FIG. 9 shows a perspective view of a razor cartridge 200 according to another embodiment of the present disclosure.

FIG. 10 shows a rear perspective view of a razor cartridge 200 according to another embodiment of the present disclosure.

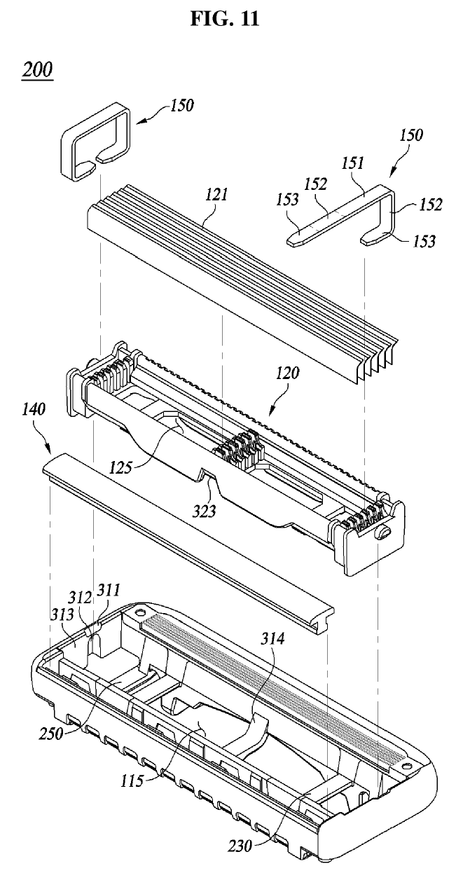

FIG. 11 shows an exploded perspective view and a partially enlarged view of a razor cartridge 200 according to another embodiment of the present disclosure.

The description of the razor cartridge 100 according to one embodiment of the present disclosure can be applied to the razor cartridge 200 according to another embodiment, except for the matters described below.

Referring to FIGS. 9 to 11, unlike one embodiment of the present disclosure in which the tension supporting unit 230 may include the first supporting unit 231 and the second supporting unit 232, a tension supporting unit 230 according to another embodiment of the present disclosure may be disposed to include only the first supporting unit 231 according to one embodiment, in other words, to only traverse a lower portion of a frame 110 along a lateral direction. However, the tension supporting unit 230 does not necessarily have to be disposed only along the lateral direction, and may be disposed in various directions including the longitudinal direction as long as the tension supporting unit 230 traverses the lower portion of the frame 110.

In the razor cartridge 200 according to another embodiment of the present disclosure, the tension supporting unit 230 may include an elastic material and may not include a component such as the second supporting unit 232 made of a plastic material. In this case, providing an excessive restoring force to a blade housing 120 can be prevented, and the movement of the blade housing 120 according to skin contours can also be made smoother.

In addition, the tension supporting unit 230 may be integrally formed with the frame 110 using a double injection molding method, and in this case, a separate assembly process for forming the tension supporting unit 230 may not be required. Furthermore, when the tension supporting unit 230 includes an elastic material, the possibility of the tension supporting unit 230 being detached from the frame 110 or damaged due to the dropping of the razor cartridge 200 or repetitive movement of the blade housing 120 can be reduced.

In FIGS. 10 and 11, the tension supporting unit 230 is illustrated as each being disposed one by one on one side and the other side in the longitudinal direction, but the tension supporting unit 230 is not necessarily limited thereto, and a plurality of tension supports may be disposed on each of one side and the other side in the longitudinal direction.

The frame 110 may be formed such that a region corresponding to at least one clip 150 for securing at least one razor blade 121 at least at one side in the longitudinal direction is open along the mounting direction. In this case, since a wall extending in the longitudinal direction from a lower portion of a frame side wall 313 may not be formed, it is possible to prevent shaving debris and water from accumulating between the blade housing 120 and the wall extending in the longitudinal direction from the lower portion of the frame side wall 313 during cleaning, and the area of the open region of the frame 110 formed along the mounting direction is widened, making it easier to clean the razor cartridge 200.

Meanwhile, each of the at least one clip 150 may include a clip body 151, a first leg portion 152 extending from the clip body 151, and a second leg portion 153 extending from one end of the first leg portion 152. While the at least one clip 150 is secured to the blade housing 120, the first leg portion 152 may extend from the clip body 151 toward the lower portion of the frame 110, and the second leg portion 153 may extend in a direction different from the extending direction of the first leg portion 152. The clip body 151 may be exposed to an outside at an upper portion of the frame 110, and the second leg portion 153 may be exposed to an outside at a lower portion of the frame 110.

Referring to FIG. 11, the razor cartridge 200 according to another embodiment of the present disclosure may be assembled in the following order.

First, the blade housing 120 may be inserted and mounted in a housing receiving space 115 of the frame 110. Thereafter, the at least one razor blade 121 may be disposed within a blade receiving space 125 of the blade housing 120. Thereafter, in order to secure the at least one razor blade 121 disposed within the blade housing 120, the clip 150 may positioned at a position adjacent to a housing side wall 322, and the first leg portion 152 and the second leg portion 153 of the clip 150 may be bent to secure the clip 150 to the blade housing 120. In this case, the at least one clip 150 may be coupled through the frame 110, and at least a portion of each of the at least one clip 150 may be exposed to an outside from a lower portion of the frame 110. More specifically, one surface of the clip body 151 may come into contact with a cutting edge, the first leg portion 152 may penetrate the housing receiving space 115 of the frame 110, and the second leg portion 153 may come into contact with a lower portion of the blade housing 120. Meanwhile, a cap portion 140 may be mounted on a rear side of the frame 110 regardless of the above-described assembly order.

Meanwhile, when viewed from one side in the longitudinal direction while the blade housing 120 is mounted on the frame 110, the housing side wall 322 may be completely covered by the frame side wall 313, but the housing side wall is not necessarily limited thereto, and a portion of the housing side wall 322 may be exposed from the frame side wall 313. For example, when the razor cartridge 200 is in a resting position, a portion of the housing side wall 322 may be exposed from the frame side wall 313.

When a portion of the housing side wall 322 is exposed from the frame side wall 313, a region adjacent to the housing side wall 322, that is, a region where the at least one clip 150 is mounted in the blade housing 120, is not completely covered by the frame 110, so that the assembly of the at least one clip 150 to the blade housing 120 may be further facilitated.

The razor cartridge 200 according to another embodiment of the present disclosure may further include at least one rib 250 which is spaced apart from the frame side wall 313 in the longitudinal direction and traverses a lower portion of the frame 110 along the lateral direction. For example, the at least one rib 250 may be disposed between the tension supporting unit 230 and the frame side wall 313 based on the longitudinal direction, but the rib is not necessarily limited thereto. Damage to the frame 200 due to dropping of the razor cartridge 200 or the like can be prevented by the at least one rib 250.

When the blade housing 120 moves up and down, the at least one rib 250 may support a lower portion of the blade housing 120, whereby excessive movement of the blade housing 120 relative to the frame 110 may be prevented. The at least one rib 250 may be made of a plastic material, but is not necessarily limited thereto.

In addition, since the at least one rib 250 may be formed further below the lower portion of the tension supporting unit 230 based on the mounting direction, excessive movement of the blade housing 120 toward the lower portion can be prevented without interfering with cleaning of the blade housing 120.

Meanwhile, the razor cartridge 200 according to another embodiment of the present disclosure may include the at least one rib 250 instead of a wall extending in the longitudinal direction from a lower portion of the frame side wall 313, and accordingly, a rotation range of the blade housing 120 about the lateral direction may be increased.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A razor cartridge comprising:
a frame comprising a receiving space formed therein;
a blade housing receiving at least one shaving blade in a longitudinal direction and mounted on the frame in a mounting direction perpendicular to the longitudinal direction to enable at least one of movement and rotation with respect to the frame; and
a tension supporting unit supporting the blade housing to provide a restorative force to restore the blade housing to a rest position when the blade housing moves or rotates relative to the frame,
wherein the frame further comprises:
a first recess formed at a top of a frame side wall; and
a second recess formed at the frame side wall and spaced apart from the first recess in the mounting direction, and
wherein the blade housing is mounted on the frame by inserting a mounting protrusion, formed in a housing side wall of the blade housing, into the second recess through the first recess.

2. The razor cartridge of claim 1, wherein at least one of the mounting protrusion or the first recess is inclined from a straight line parallel to the longitudinal direction and a straight line parallel to the mounting direction, as viewed in a cross section cut along the longitudinal direction.

3. The razor cartridge of claim 2, wherein at least a portion of the mounting protrusion and the at least a portion of the first recess are formed in shapes corresponding to each other.

4. The razor cartridge of claim 1, wherein:
the second recess is formed with one side spaced apart from the first recess in the mounting direction to receive the mounting protrusion, and
the second recess extends from the one side in the mounting direction.

5. The razor cartridge of claim 1, wherein:
the second recess is formed in a central part along a transverse direction of the frame side wall, and
the transverse direction is perpendicular to the longitudinal direction and the mounting direction.

6. The razor cartridge of claim 1, wherein the blade housing is movable upward and downward in a direction parallel to the mounting direction while mounted on the frame.

7. The razor cartridge of claim 6, wherein:
when the blade housing is located at the rest position, a contact surface of the tension supporting unit is disposed above a contact surface of the frame, and
the contact surface of the frame comes into contact with a bottom surface of the blade housing as the blade housing moves downward.

8. The razor cartridge of claim 1, wherein the blade housing is rotatable about a direction parallel to the longitudinal direction while mounted on the frame.

9. The razor cartridge of claim 1, wherein the blade housing is mounted on the frame so that the tension supporting unit is compressed at the rest position.

10. The razor cartridge of claim 1, wherein the tension supporting unit is formed integrally with the frame.

11. The razor cartridge of claim 1, wherein the tension supporting unit comprises an elastic material.

12. The razor cartridge of claim 1, wherein the tension supporting unit comprises at least one first supporting unit crossing a lower part of the frame in a transverse direction which is perpendicular to the longitudinal direction and the mounting direction.

13. The razor cartridge of claim 12, wherein:
the tension supporting unit comprises a plurality of first supporting units, and
the plurality of first supporting units are disposed on one side and the other side of the frame in the longitudinal direction.

14. The razor cartridge of claim 1, wherein the tension supporting unit comprises:
a base fixed to a lower part of the frame; and
a second supporting unit extending from the base and comprising a plurality of legs supporting the blade housing.

15. The razor cartridge of claim 14, wherein:
the base extends in a transverse direction perpendicular to the longitudinal direction, and
each of the plurality of legs extends to have at least a portion adjacent to a bottom surface of the blade housing.

16. The razor cartridge of claim 12, further comprising at least one rib which is positioned between the frame side wall and the first supporting unit based on the longitudinal direction and traverses a lower portion of the frame along a lateral direction perpendicular to the longitudinal direction and the mounting direction.

17. A razor cartridge comprising:
a frame comprising a receiving space formed therein and at least one recess formed at a side wall;
a blade housing receiving at least one shaving blade in a longitudinal direction and mounted on the frame and having a mounting protrusion inserted into the at least one recess, allowing the blade housing to be movable or rotatable relative to the frame; and
a tension supporting unit supporting the blade housing to provide a restorative force to restore the blade housing to a rest position when the blade housing moves or rotates relative to the frame,
wherein the mounting protrusion is formed in a central part of a side wall of the blade housing in a transverse direction perpendicular to the longitudinal direction.

18. The razor cartridge of claim 17, wherein:
the blade housing receives a plurality of shaving blades, and
the central part is an area with a highest density of shaving blades among areas along the transverse direction of the blade housing.

19. The razor cartridge of claim 1, wherein the blade housing is configured to tilt about an axis parallel to the transverse direction perpendicular to the longitudinal direction and the mounting direction.
